(19) United States
(12) Patent Application Publication
(10) Pub. No.: US 2013/0252732 A1
(43) Pub. Date: Sep. 26, 2013

(54) INTERACTIVE HIGH DEFINITION TV WITH USER SPECIFIC REMOTE CONTROLLERS AND METHODS THEREOF

(71) Applicant: VIRGINIA VENTURE INDUSTRIES, LLC, Centreville, VA (US)

(72) Inventor: Kenneth A. Abeloe, Carlsbad, CA (US)

(73) Assignee: Virginia Venture Industries, LLC, Centreville, VA (US)

(21) Appl. No.: 13/839,938

(22) Filed: Mar. 15, 2013

Related U.S. Application Data
(60) Provisional application No. 61/614,757, filed on Mar. 23, 2012.

(51) Int. Cl. A63F 13/00

(52) U.S. Cl. CPC A63F 13/00
USPC 463/32; 463/31

(57) ABSTRACT

Systems and methods for downloading and playing a game program on a high definition television set. The game is controlled by at least one remote controller that can be the TV manufacturer provided remote controller, cell phones, tablet devices and/or the like. The remote controller can include its own one or more displays to display information related to the game, including, for example, a figure of the game, imagery and data relating to a particular point of view including a perspective view of the player operating the remote controller, and an overview of a portion of a game space surrounding the player operating the remote control. The one or more displays can be implemented as portions of a single physical display, as separate displays on the same remote controller, or on multiple remote controllers that are physically coupled together or that are in communication with each other.

### RELATED APPLICATIONS

This application claims the benefit of U.S. Provisional Application No. 61/614,757, filed Mar. 23, 2012, which is incorporated by reference herein in its entirety.

### BACKGROUND OF THE INVENTION

1. Field of the Invention

Embodiments described herein include methods and systems relating to remote controllers for interactive video display, for example, high definition television.

2. Description of the Related Art

An owner of a High Definition (HD) TV wishing to play a popular game on the HD TV would have to purchase a game console. The console would require the purchaser to buy other accessories such as remote controllers and games. The games that can be played on the console are limited to those that play on the purchased console. This business model has been in place for a number of years. This model is not necessarily a convenient or inexpensive model for consumers because hardware devices (for example, consoles and remote controllers) need to be purchased, which are costly, and then games to play on them, which are both limited in selection and not inexpensive when a user wishes to play many different games. This is in addition to having to purchase the expensive HD TV.

Presently, an HD TV can be equipped with sufficient processing power and memory to connect to the Internet and download applications (for example, games). Once a game is downloaded, the game can be played by interacting with a remote controller that came with the HD TV or other devices that can function as remote controllers such as a tablet computer (for example, iPad, Sony Tablet S) or a cellular phone (for example, iPhone, Droid). Such a system eliminates the need to purchase games consoles. However, the level of integration between the remote controllers and HD TVs under utilize the capabilities of the HD TVs or the remote controllers due to inadequacies in currently available technologies.

### SUMMARY

It would be desirable to provide a system in which a user can experience the full capability of the HD TVs (including high resolutions and 3D features) and remote controllers, which can include a distinct display with related content. Embodiments of the present invention may be directed to a high-resolution game device that includes a high-definition television (HD TV) with a receiver or a tuner configured to demodulate a broadcast television program and a processor configured to decode a game program. The game device of the present invention may also include a game controller, which can be part of the processor, to run the game program. The game program can generate a first portion and a second portion hereinafter. In various embodiments, the first portion is changed based directly on remotely received control information and the second portion is changed based on changes occurring on the first portion. The game device may also include an image processor coupled to high-resolution display. The image processor can be configured to show or display the broadcast television program when selected to display the broadcast television program and the first and second portions of the game program when selected to play the game program. A TV program and a game program can also be played simultaneously, as in a split screen mode or a multi-scene mode.

In various embodiments of the present invention the game device can include a first portion having a different spatial resolution compared with the second portion (for example, the first portion having a lower resolution compared with the second portion). In some embodiments, the first portion can be remotely controlled by a cellular phone, tablet computer device and/or the like. In various embodiments of the present invention, remote control information can be received by the game controller, which may include a communication device. Such remote control information include identification information and movement information to control the movement of the first portion and/or information about a plurality of vertices to be used in forming an image of an object (for example, a figure of soldier, a gun, a vehicle, and/or etc.) in the first portion. Alternatively, the remote control information may also include coded texture information to be used in forming a color and a texture of the image of the object in the first portion. The communication device may also be configured to send display information to one or more remote controllers. Each remote control device can be configured to use its display screen to display images based on the display information. The display information sent to the remote controllers can be different from each other or the same.

Embodiment of the present invention may relate to one or more remote control devices. Each remote controller may include a display configured to show a representation of a first portion of a game program. Here, the game program can be configured to generate the first portion to be changed directly by control information of the remote control device and a second portion to be changed based on changes occurring on the first portion. The representation of the first portion can be lower in spatial resolution compared with the spatial resolution of the second portion. The remote control device may also include a communication device configured to send the control information to the game program. In various embodiments of the present invention, the remote control device can be a cellular phone or a tablet computer device. The control information can include identification information and movement information to control the movement of the first portion. The control information may also include a plurality of vertices to be used in forming an image of an object in the first portion and/or coded texture information to be used in forming a color and a texture of the image of the object in the first portion. The communication device may also be configured to receive display information from the game controller. The remote control device can be configured to use its display screen to display images based on the received display information.

Embodiments of the present invention may also relate to a high-resolution game system that includes a HD TV that includes an HD TV receiver/tuner configured to demodulate a broadcast television program, and a processor configured to decode a game program. The game system may also include a game controller, which can be part of the processor, to run the game program. The game controller can be configured to generate a first portion and a second portion, wherein the first portion is changed based directly on remotely received control information and the second portion is changed based on changes occurring on the first portion. The system may also include a control device remotely located from the HD TV and can be configured to generate the control information and to display a representation of the first portion, wherein the spatial resolution of the representation of the first portion can be lower compared with the spatial resolution of the second portion. The system may also include an image processor, which can be part of the processor, coupled to high-resolution display. The image processor is configured to show/display broadcast television program when selected to display the broadcast television program and the first and second portions of the game program when selected to play the game program. A TV program and a game program can also be played simultaneously, as in a split screen mode. Or, the split screen mode can allow multiple games users view different parts of the game. The first portion can be remotely controlled by a cellular phone or a tablet computer device. Remote control information to control the first portion can be received by the game controller, which may include a communication device. Such remote control information can include identification information and movement information to control the movement of the first portion. In various embodiments, the remote control information can include a plurality of vertices to be used in forming an image of an object in the first portion and/or coded texture information to be used in forming aspects of the object in the first portion. For example, such coded texture information can be used to form one or more colors, and textures, of the image of the object in the first portion, and can also be used to form certain lighting, shading, transparency, or indicia (symbols, alphanumeric characters, numbers, etc.) of the image of the object in the first portion. In various embodiments, the remote control information can include an entire display to be used in forming an image in the first portion. The communication device may also be configured to send display information to one or more remote controllers. Each remote control device can be configured to use its display screen to display images based on the display information. The display information sent to the remote controllers can be different from each other or the same.

Embodiments of the present invention may also relate to various methods including displaying high-resolution game scenes on a high-resolution television. The various methods can include the steps of demodulating a broadcast television program, running a game program that has a first portion and second portion to be displayed, generating the first portion that is changed based directly on remotely received control information, and generating the second portion is changed based on changes occurring on the first portion. The methods could also include the step of displaying the broadcast television program when selected to display the broadcast television program and the first and second portions of said game program when selected to play the game program, although they can be played simultaneously in a split screen mode. Or, the split screen mode can allow multiple games users view different parts of the game. Various embodiments of the present invention may also include the step of displaying the first portion at a different spatial resolution compared with the second portion (for example, the second portion having a higher resolution compared with the first portion). Additional steps can include the step of receiving the control information from a cellular phone and/or a tablet computer device. An additional step can be displaying, on a remote controller, a representation of the first portion that is lower in spatial resolution compared with the spatial resolution of the second portion. Other steps can be the step of receiving identification information and movement information to control the movement of the first portion as the control information, a plurality of vertices to be used in forming an image of an object in the first portion as the control information, and/or coded texture information to be used in forming a color and a texture of the image of the object in the first portion.

### BRIEF DESCRIPTION OF THE FIGURES

Various embodiments of the present invention are illustrated by way of example and not limitation in the Figures of the accompanying drawings.

FIG. 1A is a block diagram illustrating an example embodiment that includes example connections, wired or wireless, among various components.

FIG. 1B is a block diagram illustrating another example of a system where the game controller component and the television components are disposed within the same housing.

FIG. 2 is block diagram illustrating an example embodiment that includes resolution of various components and example connections, wired or wireless, among various components.

FIG. 3 is block diagram illustrating an example embodiment that includes cell phones as remote controllers and example connections, wired or wireless, among various components.

FIG. 4 is block diagram illustrating an example embodiment that includes tablet devices as remote controllers and example connections, wired or wireless, among various components.

FIG. 5 is block diagram illustrating an example embodiment that includes a connection to the Internet, various control information, example connections, wired or wireless, among various components.

FIG. 6 is a block diagram illustrating the data flow diagram for the various steps in the overall process and the interaction with various components.

FIG. 7 is a timing diagram illustrating the display sync between the game controller, remote control devices, and HD TV display.

In the figures, a component identified by a same numeral can be interpreted have similar characteristics.

### DETAILED DESCRIPTION OF CERTAIN INVENTIVE ASPECTS

While the various embodiments of the present invention are described below with reference to illustrative embodiments, this description is not intended to be construed in a limiting sense. Various modifications of the illustrative embodiments, as well as other embodiments of the invention, will be apparent to persons skilled in the art upon reference to this description.

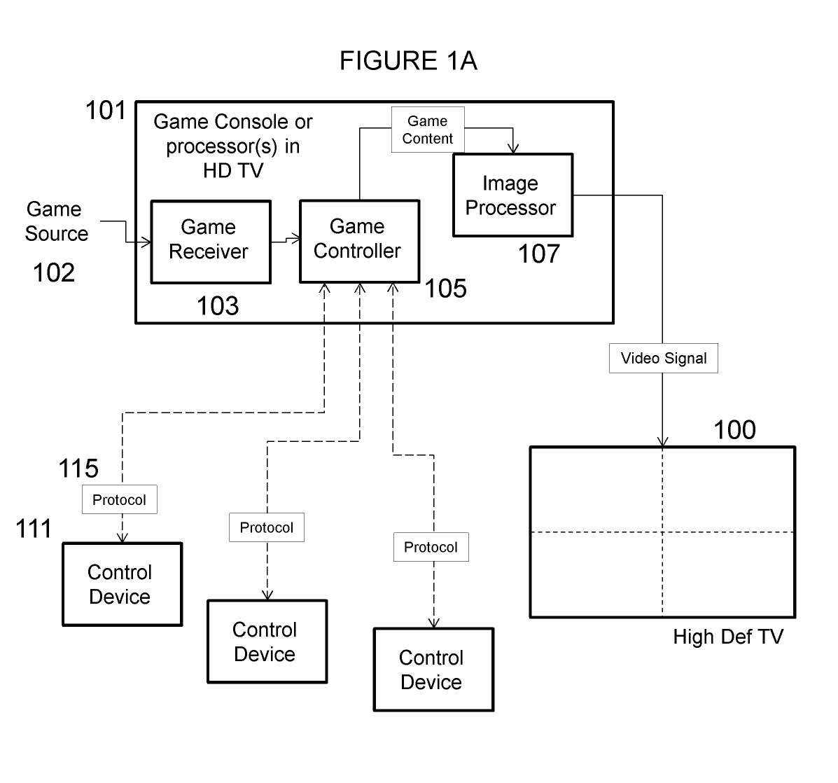

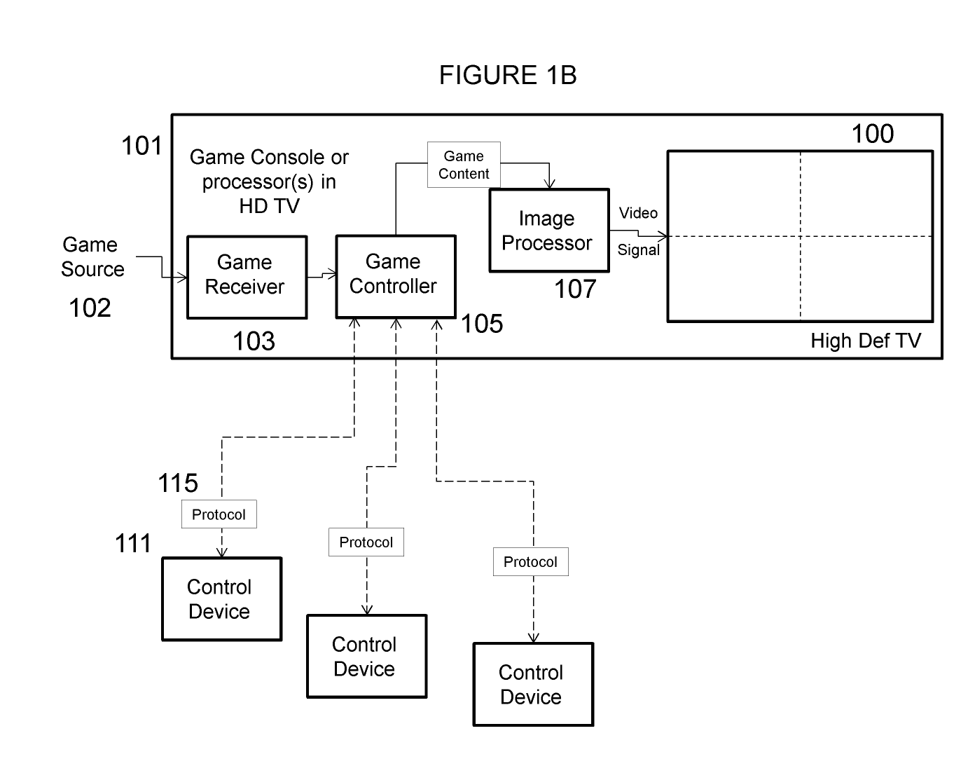

The example embodiment of the present invention illustrated in FIG. 1 includes a High Definition TV 100 (HD TV). Example HD TV can be Samsung PN64D8000 and Sony XBR HX929 Internet TV. The HD TV can also include three dimensional display capabilities for playing games with three dimensional images. The preferred size of the HD TV is 32 inches or larger.

The example embodiment of FIG. 1 also includes a game console 101. The console 101 can include a game receiver 103, game controller 105, and image processor 107. The game receiver is configured to receive one or more game programs from a game source 102. The game source can be a computer or other hardware input devices to read and download games from one or more CDs, DVDs, thumbdrives, hard drives, solid state drives and other storage media/devices. Alternatively, the game source 102 can be connected to the Internet and game console 101 can download one or more games from one or more websites of game developers/sellers. Once the one or more games are downloaded, they can be decoded and stored into memory in the game console 101, for example, in a “permanent” memory of the game receiver 103 or memory in communication with the game receiver 103, to be played later. The game receiver 103 can be configured to perform this receive and storage functionality. When a user wishes to play the downloaded game, the game controller 105 loads the game program from a permanent memory to a run-time memory. The controller 105 also receives control information from one or more of remote control devices 111 using certain protocol 115, via a communication device such as is commonly available in the Xbox 360 controller which uses a 2.4 GHz RF signal (see U.S. Pat. No. 8,130,742 which is incorporated by reference herein in its entirety) or a Sony PlayStation controller which uses a Bluetooth signal. The information in the protocol stream contains various information to control the game such a button presses for the button controls, remote device controller information (for example, information from the accelerometer and positioning system such as position, velocity, and acceleration), and timing information (for example, system clock for time sync, internally stored timing information). The remote control devices 111 can be the remote controller provided by the manufacturer of the HD TV, one or more data-ready cell phones (for example, iPhone 4), one or more tablet devices (for example, iPad 3), and/or similar devices. Each remote controller 111 can be configured to register with the game controller 105 as separate input devices. In implementations that use cell phones or tablet devices as one or more of the remote controllers, such devices can be configured with an application that can allow registration and/or communication with the game controller 105. Configuring the remote controller can include downloading an application from the Internet to allow the desired communication, or loading software from the game console 101 that was received with the game software. Such registrations are well known in the art and used in devices such as the Samsung AllShare Android apps using the Digital Living Network Alliance (DLNA) standard for HD TV.

The HD TV 100 also includes a receiver or a tuner (not shown in FIG. 1) configured to demodulate a broadcast television program. The game controller 105 can generate a first portion of information (a “first portion” hereinafter), for example, a low-resolution portion, and a second portion of information (a “second portion” hereinafter), for example, a high-resolution portion. The second portion can be videos images of general background such as a battle field scene or a race track scene. The first portion is changed based directly on remotely received control information and the second portion is changed based on changes occurring on the first portion. For instance, the first portion can depict a gun being fired and/or steering wheel therefrom. The first portion can have lower resolution images compared with the second portion. Accordingly, the first portion can be updated faster in time compared with the second portion.

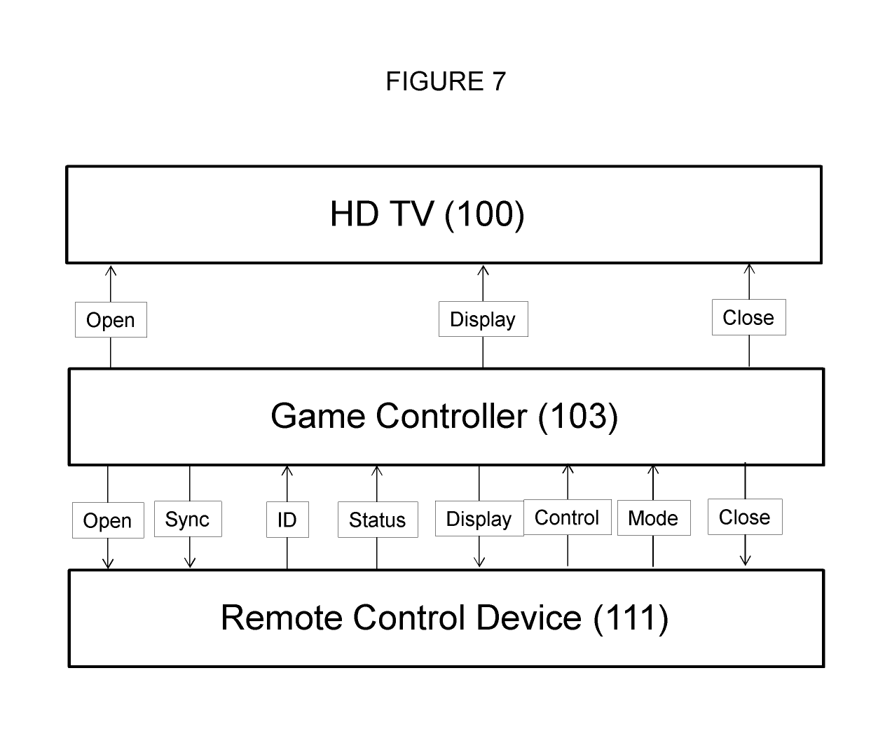

After the registrations take place between game controller 105 and remote control devices 111 as described above, each of the remote control devices 111 is associated with its own first portion. Each remote control devices 111 would control the movement/actions of the associated first portion. In addition, some of all of the remote control devices 111 can be equipped with a display screen. The display screen can receive control input from its user. The display screen can also be configured to display images or videos. In particular, if the communication device in game controller 105 and the remote control devices 111 are capable of conducting two way communications, the game controller 105 can send display information (for example, video or images) to be displayed on the display screens of the remote control devices 111. An example of video or images to be displayed is a video or images as if the user is looking through a gun sight or gun scope and/or different views from a vehicle. Each remote control device 111 can receive different set of videos or images. Alternatively, all or some (as in users forming teams) remote control devices can receive the same videos or images. A timing diagram for the display sync is shown in FIG. 7.

Examples of images/videos displayed on the remote control devices 111 and the images/videos displayed on the HD TV 100 include, but not limited to, the following scenarios:

TABLE 1

| | Displayed on the | |
|---|---|---|
| | remote control | |
| Game | devices | Displayed on the HD TV |
| Boxing Match | Front View | Bird's Eye View of Ring |
| | to Opponent | (2^{nd} portion) with boxers |
| | | (1^{st} portion) |
| Sniper Game | Scope Detailed | Overall Game at Normal |
| | View | Perspective (2^{nd} portion) |
| | | with snipers (1^{st} portion) |
| Soccer Match | Individual Player | Overall Team Position on |
| | Dribbling Ball | Field of Play (2^{nd} portion) |
| | Detailed View | with players (1^{st} portion) |
| Baseball Game | Player's View | Spectator's View of the |
| | of Ball or | Field of Play (2^{nd} portion) |
| | Glove or Bat | with players (1^{st} portion) |
| Car Racing | Player's View | Bird's Eye View of Car |
| | of Steering | (2^{nd} portion) with cars |
| | Wheel | (1^{st} portion) |
| Hunting Game | Sight Detailed | Overall Game at Normal |
| | View | Perspective (2^{nd} portion) |
| | | with hunters (1^{st} portion) |
| Instrument | Instrument | Stage and Audience Perspective |
| Type Game | Detailed View | View (2^{nd} portion) with |
| | | musicians (1^{st} portion) |

After the images to be displayed are generated, which including the first and second portions (game contents), they can be sent to image formatter 107. The image formatter 107 generates can generate video signal configure to fit on the display of the HD TV 100. If the HD TV 100 is being played in a split screen mode (for example, the display being divided into two: one half displaying a TV program and the other half for displaying the game content: the split screen mode can allow multiple games users view different parts of the game), the image formatter 107 formats the game content accordingly.

In various embodiments of the present invention, there can be three different types of views: the first and second portions and the view displayed on the remote control devices 111. The first and second portions are combined to be displayed on the HD TV 100. The views on the remote control devices 111 can be the same as the first portion or different from the first portion. For instance, in the Car Racing example provided in TABLE 1 above, the first portion would be the car. The movements of the car are controlled by the remote control device 111. The second portion would be the bird's eye of the background (for example, the road on which the car is traveling). The view on the remote control device 111 can be a representation of the car, which can be the same with the first portion on the HD TV 100. The user can use gesture events (for example, touching the screen and moving) to control the movement of the car (i.e., the first portion) on the HD TV 100. Alternatively, the view on the remote control device 111 can be a graphical representation of a steering wheel. By touching and moving the steering wheel, the user can control the movement of the car (i.e., the first portion).

It should be noted that the functions/components described herein in connection with game console 101 can, in other embodiments, also be implemented/included in the HD TV 100 itself, as illustrated in FIG. 1B. For example, the game receive 103, game controller 105, and image processor 107 can be internal components to the HD TV 100 such that they are in one housing. It should also be noted that the game receive 103, game controller 105 and image processor 107 can be implemented in a combination of hardware and software. As for the hardware for components of the described embodiments, in various implementations the functions can be implemented on one or more processors.

The HD TV 100 may also include an image processor, which can be part of another processor, coupled to high-resolution display. The image processor can be configured to show or display the broadcast television program when selected to display the broadcast television program and the first and second portions of the game program when selected to play the game program.

In the embodiment depicted in FIG. 1, the protocol 115 can include identification information and movement information to control the movement of the first portion. The protocol can also include information about a plurality of vertices to be used in forming an image of an object (for example, a figure of soldier, a gun, and/or etc.) in the first portion. Alternatively, the protocol 115 may also include coded texture information to be used in forming a color and a texture of the image of the object in the first portion.

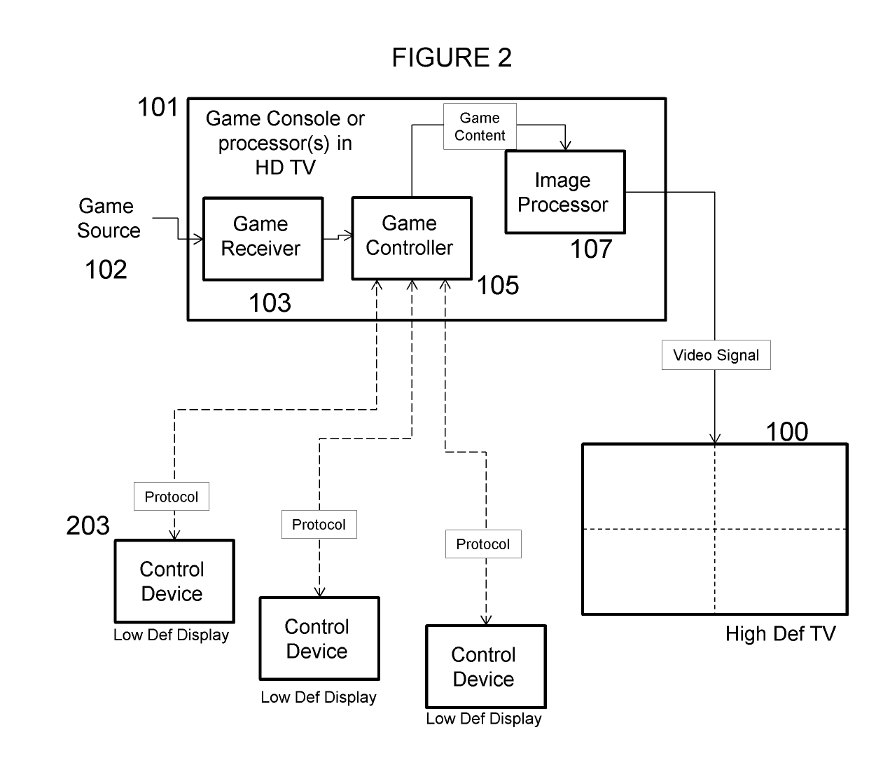

In FIG. 2, there is shown a control device 203, each having its own display. Such a display would show a lower definition image consistent with examples to include in TABLE 1 above. In these cases, the first portion of the game content can be lower resolution with the associated lower amount of content.

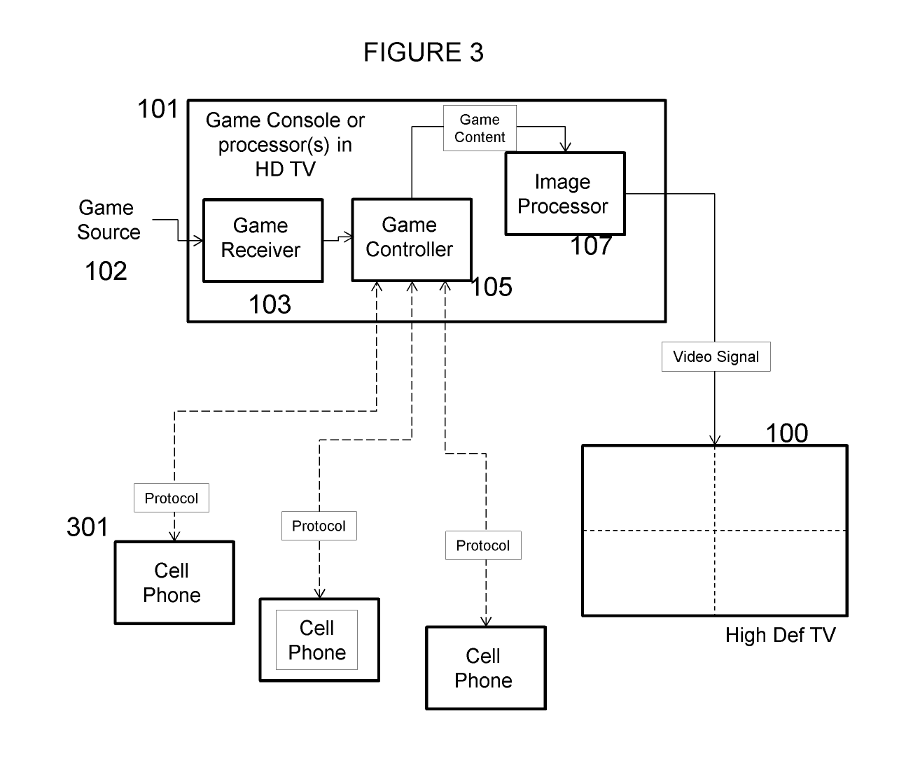

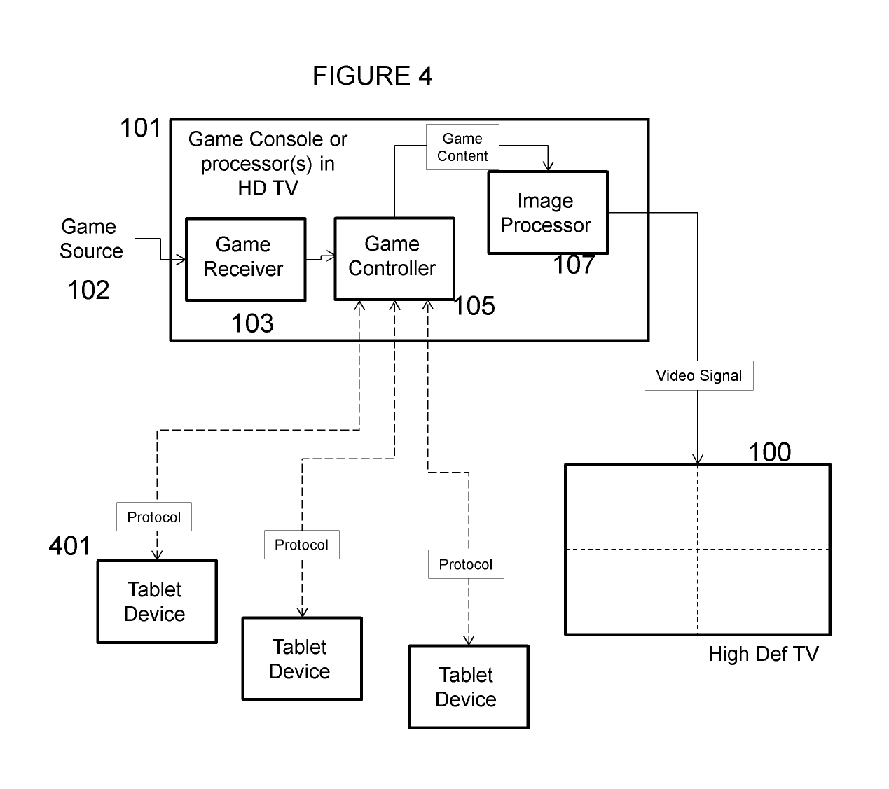

In FIG. 3, there is shown a control device 301 implemented on a smart cell phone. In FIG. 4, there is shown a control device 401 implemented a tablet device. In the embodiments that the remote control function is implemented on a smart phone or tablet devices, applications (“apps”) can be downloaded. Such apps can be configured to carry out the features of the remote control device 111 as described herein.

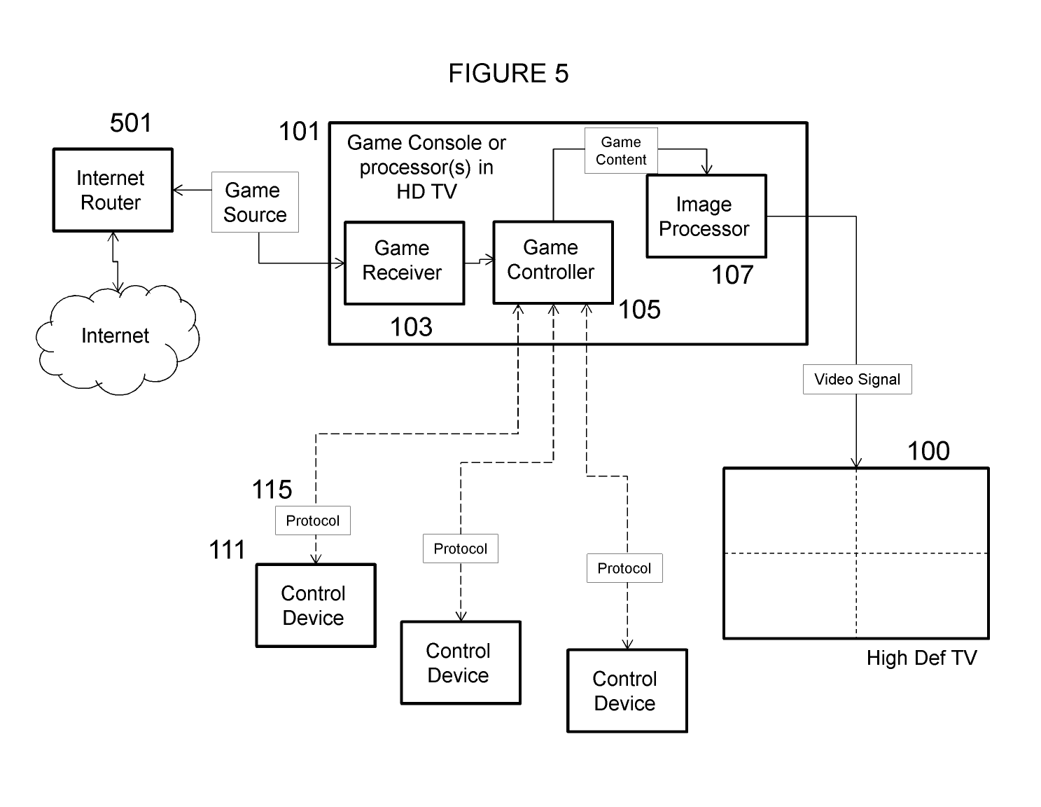

In FIG. 5, the FIG. 1 embodiment is shown with device 501 connecting to the Internet at 501. The game receiver 103 can download games from the Internet onto the game controller 105 through a wired or wireless network connection (for example, TCP/IP). In some embodiments, games and/or information related to the games can be received (for example, downloaded) from both the Internet and a storage media (for example, CDs, DVDs, thumbdrives, solid state drives, etc.).

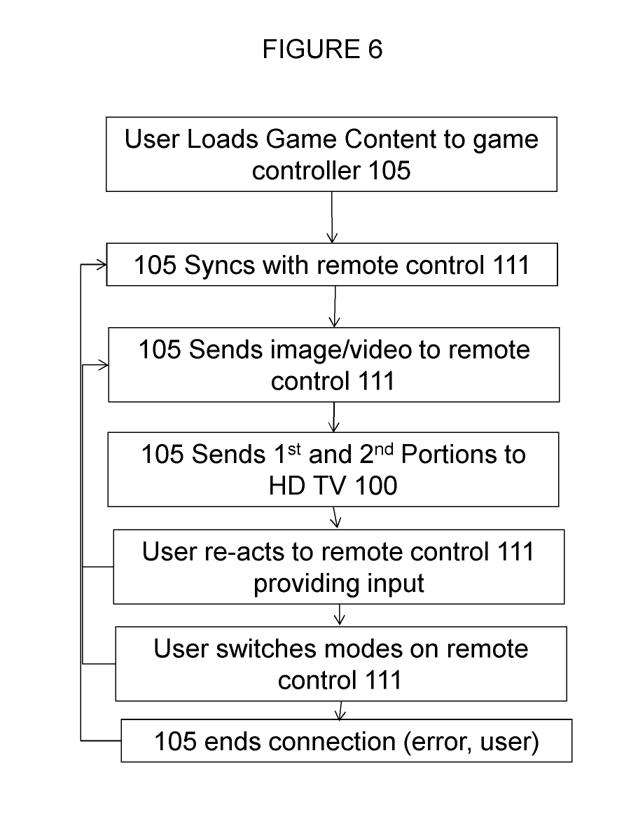

In FIG. 6, a flow chart illustrates various steps or processes of various embodiments. The user loads a game on the game controller 105. The game controller 105 synchronizes with remote control devices 111. Each of the remote control devices 111 can provide, or is otherwise assigned, a unique identifier and a viewer mode back to 103 for subsequent viewing. The game controller 105 device sends the 1^{st} portion to corresponding remote controllers 111. Then, the game controller 105 sends the first and second portion to HD TV 100. Here, the first image/video of the first portion can be a default image/video at a default position. The users provide input through remote control devices 111. The users may also switch modes in game controller 105. The game controller 105 then updates based on the inputs from the users and the first and second portions at the HD TV 100. Upon an error (for example, disconnect between the game controller 105 and remote control device 111), the game controller 105 can attempt to establish communications again or exit.

In FIG. 7, a timing diagram illustrates the timing relationship between various components. Upon initialization (for example, game loaded into the memory of the game controller 105), the game controller 105 opens a connection between the HDTV 100 and the remote control device 111. In addition, the game controller 103 requests synchronization between HD TV 100 and remote control devices 111 to include each remote control devices 111 passing a unique identifier and a status message where the status message is the state of each of the respective remote control devices (for example, position, button configuration, operating mode). The game control device 105 then initiates the game and provides the first and second portions to the HD TV 100. Based on user control input communicated from at least one remote control devices 111, the game controller 105 may provide control updates and/or mode updates. The game controller 105 then may provide an updated first portion and may provide an updated second portion to the HD TV 100.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations (or embodiments) also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

What is claimed is:

1. A high-resolution game device, comprising:
a high-resolution television (HD-TV) receiver configured to demodulate a broadcast television program;
a game receiver configured to decode a game program;
a game controller configure to run the game program, said game program generating a first portion and a second portion, wherein said first portion is changed based directly on remotely received control information and said second portion is changed based on changes occurring on the first portion; and
an image processor coupled to a high-resolution display, said image processor configured to show said broadcast television program when selected to display said broadcast television program and said first portion and second portion of said game program when selected to play said game program.

2. The device of claim 1, wherein said first portion has a different spatial resolution compared with the second portion.

3. The device of claim 1, wherein the first portion is remotely controlled by a cellular phone.

4. The device of claim 1, wherein said first portion is remotely controlled by a tablet computer device.

5. The device of claim 1, wherein said remote control information includes identification information and movement information to control the movement of the first portion.

6. The device of claim 5, wherein said remote control information includes a plurality of vertices to be used in forming an image of an object in the first portion.

7. The device of claim 6, wherein said remote control information includes coded texture information to be used in forming a color and a texture of the image of the object in the first portion.

8. A remote control device, comprising:
a display configured to show a representation of a first portion of a game program, said game program configured to generate the first portion to be changed directly by control information of the remote control device and a second portion to be changed based on changes occurring on the first portion, wherein the representation of the first portion is lower in spatial resolution compared with the spatial resolution of the first portion; and
a communication device configured to send the control information to the game program.

9. The device of claim 8, wherein said first portion has a different spatial resolution compared with the second portion.

10. The device of claim 8, wherein said device is a cellular phone.

11. The device of claim 8, wherein said device is a tablet computer device.

12. The device of claim 8, wherein said control information includes identification information and movement information to control the movement of the first portion.

13. The device of claim 12, wherein said control information includes a plurality of vertices to be used in forming an image of an object in the first portion.

14. The device of claim 13, wherein said control information includes coded texture information to be used in forming a color and a texture of the image of the object in the first portion.

15. A method of displaying high-resolution game scenes on a high-resolution television, the method comprising:
demodulating a broadcast television program;
running a game program that has a first portion and second portion to be displayed;
changing the first portion based on remotely received control information;
changing the second portion based on changes of the first portion; and
displaying said broadcast television program when selected to display said broadcast television program and said first portion and second portions of said game program when selected to play said game program.

16. The method of claim 15, further comprising the step of displaying said first portion at a different spatial resolution compared with the second portion.

17. The method of claim 15, further comprising the step of receiving the control information from a cellular phone.

18. The method of claim 15, further comprising the step of receiving the control information from a tablet computer device.

19. The method of claim 15, further comprising the step of displaying, on a remote controller, a representation of the first portion that is lower in spatial resolution compared with the spatial resolution of the first portion.

20. The method of claim 15, further comprising the step of receiving identification information and movement information to control the movement of the first portion as the control information.

21. The method of claim 20, further comprising the step of receiving a plurality of vertices to be used in forming an image of an object in the first portion as the control information.

22. The method of claim 21, further comprising the step of receiving coded texture information to be used in forming a color and a texture of the image of the object in the first portion.
